(19) United States
(12) Patent Application Publication
(10) Pub. No.: US 2008/0043725 A1
(43) Pub. Date: Feb. 21, 2008

(54) Method for placing VoIP calls through a web-based interface and system of the same

(75) Inventor: Yun-Lung Wan, Taipei (TW)

Correspondence Address: BACON & THOMAS, PLLC, 625 SLATERS LANE, FOURTH FLOOR, ALEXANDRIA, VA, 22314, US

(73) Assignee: InfoAction Technology, Inc., Taipei (TW)

(21) Appl. No.: 11/730,268

(22) Filed: Mar. 30, 2007

(30) Foreign Application Priority Data
Mar. 30, 2006 (TW) 095111334

(51) Int. Cl. H04L 12/66

(52) U.S. Cl. 370/352

(57) ABSTRACT

The present invention provides a novel method and system for placing VoIP calls through a web-based interface. With the present invention, the enterprise can easily build up their VoIP telecom system, and manage it with high security. Furthermore, the method may help the enterprise reduce the telecommunication cost. The method placing VoIP calls through web-based interfaces comprises a step of logining on a web-based interface by a caller to get a contact list. Then, the caller selects a callee from the contact list; the web-based interface checks the callee's status. Subsequently, the system constructs a VoIP connection of a VoIP protocol between the caller and the callee when the callee is available. Next, the web-based interface controls a VoIP gateway after said VoIP connection is built. The next step is to control a PBX (private branch exchange) by the VoIP gateway to ring back a caller's extension.

### FIELD OF THE INVENTION

The present invention relates to a method and a system for placing VoIP calls, and more particularly to a method and a system for placing VoIP calls through a web-based interface.

### BACKGROUND OF THE INVENTION

Since the 90's, with the rapid changes in World Wide Web (internet), more and more applications used for internet has been developed. The number of people using internet has grown rapidly, which means that internet becomes more and more important to our daily life. People use internet not only for recreation but also for some serious reasons, for example, networking can reduce physical distances between two persons and help them to communicate with each other.

One of the most significant applications for internet user is instant message (IM) on network, such as ICQ, MSN messenger, AOL messenger, Google talk or the like. In this type of networking IM application, people may first login to a server which provides the interface for communication. The server usually is provided by IM software provider, the creator of the IM application. The login process only accepts the specific IM application, means if the user want to login on this server, the user must download and install some acceptable IM software. After successfully login on the server, the system allows the user to communicate with each other by inputting message through typing the communication information. Under such arrangement, user can talk with multiple people at the same time. This is very different from the ordinary communication ways, like the telephone. Although this way of communicating seems a perfect solution for communication, it is still having many major drawbacks. For instance, it's only supported by typing; this means that if the one can not type the message into personal computer correctly and efficiently, user may not achieve the goal of communicating with others. Many elder or traditional people are not familiar with typing skill; this causes that only younger persons really gain the benefit of this service. That makes IM service not as popular as the traditionally telecom service. Besides, prior to using IM service, users have to install the IM software onto their personal computer, and these procedures let the entry barrier of IM service become higher and higher. According to these disadvantages, IM service only can be the “toy” for leisure times.

With huge development of network technology, the total bandwidth of the internet grows rapidly, and produces are more available for bandwidth and IM service than ever. Under such condition, service providers start to provide voice service of IM service, which is well-known as VoIP technology. The voice service should be provided according to user's demand, and introduces more people to use the service. The major provider of this kind service is the skype, and there are many companies joining this field, for example MSN messenger, Google talk and ICQ also added voice service on their latest version of service. However, before you really start to use the voice service, you still need to install specific software in order to login on the server. Furthermore, users need to connect various accessories to their personal computer, like microphone, headphone etc. Taking an enterprise office as an example, employees may use VoIP to communication, and employer may also want to use VoIP for cost-down. The enterprise fails to control and management the VoIP calls in enterprise at present. No any efficient solution is provided; employer is unlikely to know whether employees utilize the service for work or just messing around. Besides, application for placing a VoIP call is usually highly platform oriented, means it is very difficult to reach the purposes of platform-free.

In view of foregoing drawbacks, it is urgently required to have a method and a system for control and management of the VoIP calls, which is platform-free. The present invention therefore can match all the requirements.

### SUMMARY OF THE INVENTION

The present invention fills the needs by providing a method and a system for placing VoIP calls through a web-based interface. It should be appreciated that the present invention can be implemented in numerous ways, including as a process, a system and a method. By using the method and system of the present invention, enterprise can easily build up and manage their VoIP network. Moreover, users can place a VoIP call by the method which is more suitable for their behavior.

The VoIP technology focus on using the existing internet protocols to provide a user-friendly telecom environment. Although there are a lot of companies manufacture various support devices for VoIP environments, however, most of them fail to meet enterprise's needs of VoIP communication. The main issues are security and management consideration. The VoIP clients are not easy to be monitored, and the setup of application needs extra computer skill, it is unlikely to be done by common users. Therefore, although VoIP network is much cheaper than ordinary telecom services, especially international telecommunication service, VoIP network is still not as popular as predicted by enterprises.

The purpose of the present invention is to place VoIP calls through the web-based interface. Caller may use different kinds of client devices to login on the web-based interface. The web-based interface may use IP (Internet Protocol) for data stream transfer in bi-direction, and the client device may receive data stream from web-based interface. After login on the web-based interface, the caller can get his own contact list, which shows the callees' data in a skype-like way. The caller selects a callee from contact list by simply clicking on callee's nickname or alias. Subsequently, the web-based interface starts to check the availability of the callee. If the callee is available for placing a call, the web-based interface determines to choose one of the available lines. Then, the system builds up a connection between the caller and the callee under VoIP protocol. When the connection is successfully built by the system, the web-based interface sends control signal to the VoIP gateway; then the VoIP gateway notifies a PBX (private branch exchange) to ring back the caller's extension. When the caller hears that his/her extension is ringing, the caller only needs to answer the phone by the conventional physical telephone instead of through the computer system. The main advantage in this method is that the caller doesn't need to install additional software into the computer, and after selecting the callee, the caller just waits for the extension ringing. Furthermore, enterprise can easily manage employees' VoIP accounts by web-based interfaces, but does not need to fully forbid the use of IM services or VoIP services.

Another purpose of the present invention is providing a system for placing VoIP calls through the web-based interface, and provides an exemplary connection of the system. The system includes a VoIP gateway, PBXs, a web-based interface, a client device and at least one caller's extension; wherein the client device is connected to the web-based interface by LAN (local area network). The web-based interface is connected to the WAN (wide area network). The web-based interface is connected to the VoIP gateway; the PBX is connected to the VoIP gateways; and the caller's extension is coupled to PBXs. Furthermore, the present invention also provides detailed functional diagram of the web-based interface as set in the detailed description.

### BRIEF DESCRIPTION OF THE DRAWINGS:

The present invention will be readily understood by the following detailed description in conjunction with the accompanying drawings.

FIG. 1 is a flow chart of method for placing VoIP calls through the web-based interface.

FIG. 2 is a block diagram illustrating a system for placing VoIP calls through the web-based interface.

FIG. 3 is a functional diagram reciting parts of the web-based interface.

### DETAILED DESCRIPTION OF THE PREFERRED EMBODIMENTS:

The present invention is described with preferred embodiments and accompanying drawings. It should be appreciated that all the embodiments are merely used for illustration. Although the present invention has been described in term of a preferred embodiment, the invention is not limited to this embodiment. It will be understood, however, to one skilled in the art, that the present invention may be practiced without some or all of these specific details. In other instances, well known process operations have not been described in detail in order not to unnecessary obscure the present invention.

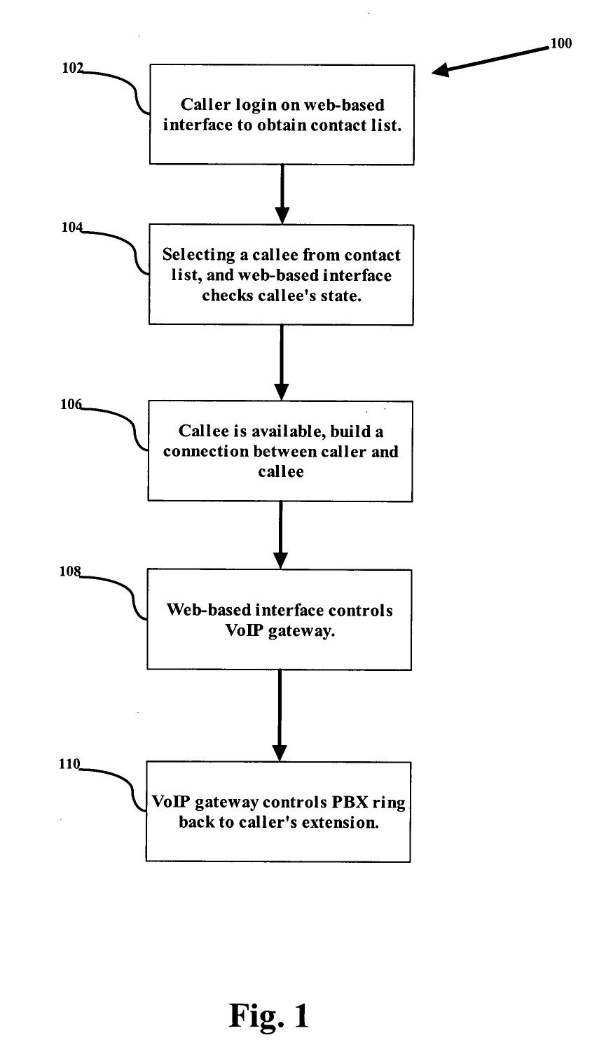

Referring to FIG. 1, which is a flow chart of method for placing VoIP calls through a web-based interface, wherein the whole process is labeled as process 100. The process 100 starts at step 102; caller may use different kinds of client devices to login on the web-based interface, the aforementioned client device includes, but not limited to, a personal computer, a PDA (personal digital assistant), a CDMA, PHS, GSM mobile phone and a 3G mobile phone or the like. The web-based interface is compatible or available for the use of IP (Internet Protocol) for data stream transfer in bi-direction, and the client device may receive data stream from the web-based interface, then pass to a browser, which is used for parsing received data stream to user viewable forms. The browser is typically installed in the client device, including any browser supporting IP, like IE, Firefox, and embedded browser. The web-based interface includes a web server, a database, a system layer and a JAVA interface. There are several VoIP numbers (or accounts) installed in the web-based interface, and can supply a plurality of available lines for placing VoIP calls. By login on the web-based interface, caller can get his own contact list, which is showing callees' data in a skype-like way. After caller receives the contact list, whole process moves to step 104; the caller selects a callee from the contact list by simply clicking on callee's nickname or the alias; the web-based interface starts to check availability of callee. In order not to obscure the present invention, the availability of the callee is meant that the callee is available for building network connection or not, but is not meant to the status of the callee within his VoIP software. In step 106, if the callee is available for building the network connection, the web-based interface chose one of the available lines; then builds up a VoIP connection between the caller and the callee under a specific VoIP protocol. When the connection is successfully built, refer to step 108, the web-based interface sends a control signal to a VoIP gateway. Subsequently, in step 110, the VoIP gateway notifies PBX (private branch exchange) ring back the caller's extension. When the caller hears his/her extension ringing, the caller only needs to answer the phone. The aforementioned VoIP gateway can be a software gateway or a hardware gateway; the software gateway is designed in a manner of software for installing on a personal computer; the hardware gateway is designed in an independent manner and does not be supported by other hardware device.

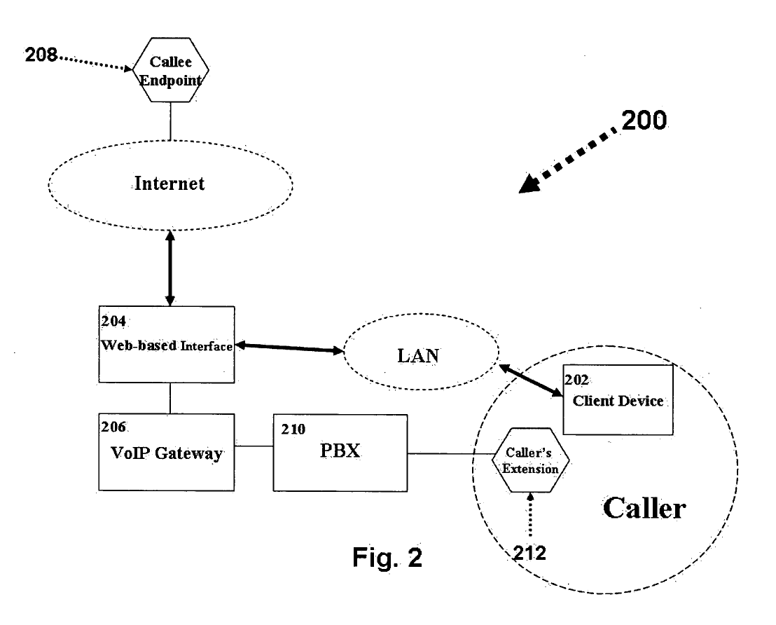

Referring to FIG. 2, it is a block diagram illustrating a system 200 for placing VoIP calls through the web-based interface. The system 200 includes a client device 202, a web-based interface 204, a VoIP gateway 206, a callee endpoint 208, a PBX 210 and a caller's extension 212. The client device 202 is connected or coupled to the web-based interface 204 through a LAN (local area network); the LAN also can be a WLAN (wireless LAN). Thus, the communication could be implemented by physical connection or wireless connection. The client device 202 is used for login on the web-based interface 204; the client device 202 includes a personal computer, a PDA (personal digital assistant), a CDMA, PHS, GSM mobile phone, a 3G mobile phone or the like. The web-based interface 204 might be made up by the combination of a web server, a database, a system layer and a JAVA interface. Moreover, the web server can be Apache, IIS; the database can be MySQL, MSSQL, or Oracle; the system layer uses for connecting the upper layer with operating system (OS), the OS can be any platform; and the JAVA interface is used for multi-platform purpose, it can provide the web-based interface 204 having stronger compatibility. Moreover, other interfaces which have similar functionalities of the JAVA, AJAX, and Flash™ interface also can be used within the system in order to extend additional choices. The web-based interface 204 may introduce or use IP (Internet Protocol) for data stream transfer in bi-direction with the client device 202, and the client device 202 receives data stream from the web-based interface 204, then pass to a browser, which is utilized for the purpose of parsing received data stream to user viewable forms. The browser is installed in the client device 202, including any browser supporting IP, like IE (Internet Explorer), Mozilla Firefox, and other embedded browsers. Moreover, the web-based interface 204 can provide the functions including checking availability of callee's endpoint 208, choosing available VoIP lines, monitoring available VoIP lines, adding/deleting/backing up/browsing caller's contact list, adding/deleting/backing up/browsing the setting of additional VoIP numbers/accounts, signaling the VoIP gateway 206 and building the connection between caller and callee. The VoIP gateway 206 can be a software gateway and a hardware gateway; the connection between the web-based interface 204 and VoIP gateway 206 can be USB (universal serial bus). Furthermore, there may be multiple VoIP gateways connected to the web-based interface 204. Besides, the connection from VoIP gateway 206 to PBX is bi-direction; it is implemented by RJ-11. The web-based interface 204 can be installed with a plurality of VoIP numbers (accounts), which is managed by the web-based interface. The types of VoIP protocol are unlimited, the choice is made by the compatibility among caller and callee endpoint 208. The VoIP protocol can be H.323, SIP, Skinny, or other VoIP protocols. The callee endpoint 208 is connected with internet, and it represents the location where the callee is. Caller can select the callee from the contact list after login on the web-based interface 204. The PBX 210 is used for distributing incoming phone to extension within the enterprise. In system 200, the PBX 210 can be an analog PBX, a digital PBX and an IP-PBX. In other words, enterprise can continue to use their existing in-line telecom network, or enterprise can upgrade network to meet newer standard. The caller's extension 212 is chosen with the PBX 210, it can be a traditional telephone set, or suitable type for the PBX 210, for example a digital telephone set.

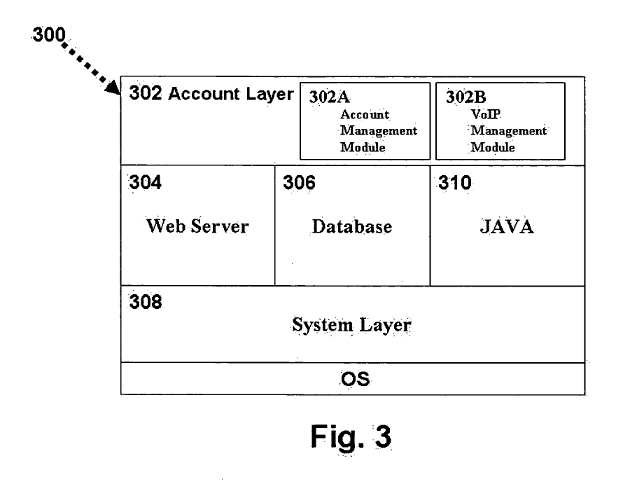

Referring to FIG. 3, it shows a functional diagram reciting parts of the web-based interface 300, and the web-based interface 300 is merely one of the preferred examples of the web-based interface 204. The web-based interface 300 is made up by the combination of an account layer 302, a web server 304, a database 306, a system layer 308 and a JAVA interface 310. Furthermore, every module are separated by layering from bottom to top, there is an OS layer, a system layer, an application layer and an account layer. The application layer over the system layer includes the web server 304, the database 306 and the JAVA interface 310. Moreover, the web server 304 can be Apache, IIS; the database 306 can be MySQL, MsSQL, or Oracle; the system layer 308 is used for connecting the upper layer with operating system (OS), the OS can be any platform; and the JAVA interface 310 is introduced for multi-platform purpose, can provide the web-based interface 300 with stronger compatibility. The web-based interface has been installed a plurality of VoIP numbers/accounts on the account layer 302 which is managed by an account management module 302A within the account layer 302, and each account/number stands for one available line for placing VoIP calls; all lines are under the management of a VoIP management module 302B which is embedded in the account layer 302. Moreover, the VoIP management module 302B which is embedded in the account layer 302 can provide the functions including checking availability of callee's endpoint, choosing available VoIP lines, monitoring available VoIP lines, signaling the VoIP gateway and building the connection between caller and callee. The account management module 302A within the account layer 302 is with the function for adding/deleting/backing up/browsing caller's contact list and adding/deleting/backing up/browsing the setting of additional VoIP numbers/accounts.

Other embodiments of the invention will be apparent to those skilled in the art from consideration of the specification and practice of the invention. The word “comprising” and forms of the word “comprising” as used in the description and in the claims are not meant to exclude variants or additions to the invention. Furthermore, certain terminology has been used for the purposes of descriptive clarity, and not to limit the present invention. The embodiments and preferred features described above should be considered exemplary, with the invention being defined by the appended claims.

We claim:

1. A method for placing VoIP calls through web-based interfaces, the method comprising steps:
loginning on a web-based interface by a caller to get a contact list;
selecting a callee from said contact list by said caller, said web-based interface checking said callee's status;
building a VoIP connection of a VoIP protocol between said caller and said callee when said callee is available;
controlling a VoIP gateway by said web-based interface after said VoIP is connected;
controlling a PBX (private branch exchange) by said VoIP gateway to ring back a caller's extension.

2. The method of claim 1, wherein said VoIP protocol comprises H.323, SIP, or Skinny.

3. The method of claim 1, wherein said PBX comprises an analog PBX, a digital PBX or an IP-PBX.

4. The method of claim1, wherein said VoIP gateway comprises software VoIP gateway or hardware VoIP gateway.

5. A system for placing VoIP calls through web-based interfaces, the system comprising:
a web-based interface coupled to an internet;
a client device coupled to said web-based interface;
a VoIP gateway coupled to said web-based interface;
a PBX coupled to said VoIP gateway;
a caller's extension coupled to said PBX.

6. The system of claim 5, wherein said client device comprises a personal computer, a PDA (personal digital assistant), a PHS, CDMA, GSM mobile phone or a 3G mobile phone.

7. The system of claim 5, wherein said VoIP gateway comprises a software VoIP gateway or a hardware VoIP gateway.

8. The system of claim 5, wherein said PBX comprises an analog PBX, a digital PBX or an IP-PBX.

9. The system of claim 5, wherein said web-based interface further comprises a web server, a database, a JAVA interface and a system layer.

11. The system of claim 5, wherein said web-based interface further comprises an OS (operating system) layer on bottom, a system layer over said OS layer, an application layer over said system layer and an account layer over said application layer.
